(19) United States
(12) Patent Application Publication
(10) Pub. No.: US 2019/0149750 A1
(43) Pub. Date: May 16, 2019

(54) HIGH FRAME RATE MOTION FIELD ESTIMATION FOR LIGHT FIELD SENSOR, METHOD, CORRESPONDING COMPUTER PROGRAM PRODUCT, COMPUTER READABLE CARRIER MEDIUM AND DEVICE

(71) Applicant: INTERDIGITAL CE PATENT HOLDINGS, PARIS (FR)

(72) Inventors: Cedric THEBAULT, CHANTEPIE (FR); Benoit VANDAME, Betton (FR); Neus SABATER, BETTON (FR)

(21) Appl. No.: 16/098,860

(22) PCT Filed: May 4, 2017
(86) PCT No.: PCT/EP2017/060617

§ 371 Date: Nov. 4, 2018

(30) Foreign Application Priority Data
May 4, 2016 (EP) 16305518.9

(51) Int. Cl. H04N 5/345; H04N 13/232; H04N 13/271; H04N 5/235

(52) U.S. Cl. CPC H04N 5/3452; H04N 5/2353; H04N 13/271; H04N 13/232

(57) ABSTRACT

A method for processing data acquired by a sensor pixel array (SPA) of a plenoptic camera is provided. The sensor pixel array (SPA) comprises a plurality of rows and columns of pixels and the plenoptic camera comprises a micro-lens array (MLA) delivering a set of micro-lens images on said sensor pixel array (SPA), each micro-lens image covering at least partially a number of rows and a number of columns of said sensor pixels array. The method for processing data acquired by the sensor pixel array comprises reading-out rows or columns of pixels according to a reading-out order, the reading-out order being defined as a function of said number of rows and/or number of columns and of a number of micro-lens images.

### 1. FIELD OF THE DISCLOSURE

The present disclosure lies in the field of image processing and relates to a technique for processing data acquired by a sensor pixel array. More precisely, the disclosure pertains to a technique for processing data acquired by a sensor pixel array of a plenoptic camera.

### 2. BACKGROUND

The present section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Conventional image capture devices render a three-dimensional scene onto a two-dimensional sensor. A conventional capture device captures a two-dimensional (2D) image representing an amount of light that reaches each point on a photosensor within the device. However, this 2D image contains no information about the directional distribution of the light rays that reach the photosensor (may be referred to as the light-field). Depth, for example, is lost during the acquisition. Thus, a conventional capture device does not store most of the information about the light distribution from the scene.

Light-field capture devices (also referred to as “light-field data acquisition devices”) have been designed to measure a four-dimensional light-field of the scene by capturing the light from different viewpoints of that scene. Thus, by measuring the amount of light traveling along each ray of light that intersects the photosensor, these devices can capture additional optical information (information about the directional distribution of the bundle of light rays) for providing new imaging applications by post-processing. The information acquired by a light-field capture device is referred to as the light-field data. Light-field capture devices are defined herein as any devices that are capable of capturing light-field data.

Light-field data processing comprises notably, but is not limited to, generating refocused images of a scene, generating perspective views of a scene, generating depth maps of a scene, generating extended depth of filed (EDOF) images, generating stereoscopic images, and/or any combination of these.

There are several types of light-field capture devices, among which:

plenoptic cameras, which use a micro-lens array placed between the photo-sensor and the main lens, as described for example in document US 2013/0222633;

a camera array, where all cameras image onto a single shared image sensor or different image sensors.

The present disclosure focuses more precisely on plenoptic cameras, which are gaining a lot of popularity in the field of computational photography. Such cameras have novel post-capture processing capabilities. For example, after the image acquisition, the point of view, the focus or the depth of field can be modified. Also, from the obtained sampling of the light field, the scene depth can be estimated from a single snapshot of the camera.

As schematically illustrated in relation with FIG. 1, a plenoptic camera uses a micro-lens array (MLA) positioned in the image plane of a main lens (L) and in front of a sensor pixel array (SPA) on which one micro-image per micro-lens is projected (also called “sub-image” or “micro-lens image”). The sensor pixel array (SPA) is positioned in the image plane of the micro-lens array (MLA). The micro-lens array (MLA) comprises a plurality of micro-lenses uniformly distributed, usually according to a quincunx arrangement.

FIG. 2 shows an example of the distribution of micro-lens images projected by a micro-lens array onto the sensor pixel array (SPA). The sensor pixel array (SPA) comprises a plurality of rows and columns of pixels, and each micro-lens image covers at least partially a predetermined number of rows and a predetermined number of columns of this sensor pixels array (SPA).

A plenoptic camera is designed so that each micro-lens image depicts a certain area of the captured scene and each pixel associated with that micro-lens image depicts this certain area from the point of view of a certain sub-aperture location on the main lens exit pupil.

The raw image obtained as a result is the sum of all the micro-lens images acquired from respective portions of the sensor pixel array. This raw image contains the angular information of the light field. Angular information is given by the relative position of pixels within the micro-images, with respect to the centre of these micro-lens images. Based on this raw image, the extraction of an image of the captured scene from a certain point of view, also called “de-multiplexing” in the following description, is performed by reorganizing the pixels of this raw image in such a way that all pixels capturing the scene with a certain angle of incidence are stored in a same pixel grid (also referred to as “view” throughout the rest of the document). Each view gathers, in a predefined sequence, the pixels of the micro-lens images having the same relative position with respect to their respective centre (i.e. the pixels which are associated with a same given viewing angle), thereby forming a pixel mosaic. Each view therefore has as many pixels as micro-lenses comprised in the micro-lens array (MLA), and there are usually as many views as pixels per micro-lens image.

For example, each micro-lens image of FIG. 2 covers at least partially nine pixels, thus allowing the generation of nine views (V1, V2, . . . , V9) of the captured scene, each view corresponding to the scene seen from a particular viewing angle.

In any image capture device, sensor exposure to light is a critical parameter. In addition to or in substitution of mechanical shutter that may be used in such devices, sensor themselves now comprises electronic shutter means to control their exposure to light. Two main techniques are currently used by image sensor to electronically control how and when light gets recorded during an exposure: the global shutter technique and the rolling shutter technique.

The rolling shutter technique is a method of image recording where data is read-out from the sensor row by row, sequentially, usually from top to bottom (or, as an alternative, column by column, sequentially, from left to right for example). In other words, the rows of pixels of the image sensor are not exposed to light at the same time.

Conversely, a sensor that implements global shutter technique captures the entire image at the same time and then reads the information after the capture is completed, rather than reading top to bottom during the exposure. To some extent, with global shutter, everything happens as if all the rows of pixels of the photo-sensor were read out at a same time.

The shutter technique used in conjunction with a given sensor is closely linked to this sensor design. That is why CMOS (Complementary Metal Oxide Semiconductor) sensors mostly rely on rolling shutter technique, whereas the global shutter technique is usually the one implemented within CCD (Charge Coupled Device) sensors.

Most of the image capture devices on the consumer imaging market, including plenoptic cameras, have CMOS sensors, mainly because they are less expensive than CCD sensors. As a result, the rolling shutter technique is widely used.

One well-known drawback of the rolling shutter technique is that it can lead to image artefact under certain circumstances, because the rows of the image sensor are not exposed at the same time. Image distortions may appear when capturing a fast moving object for example. Partial exposure of an image may also happen when light conditions change abruptly (i.e. when light conditions change between the exposure of the top of the image sensor and the exposure of the bottom of the image sensor).

These undesirable rolling shutter effects, which may prove problematic within conventional image capture device, are even more problematic within devices such as plenoptic camera. Indeed, as already explained above in relation with FIG. 2, the data acquired by a sensor pixel array of a plenoptic camera have to be de-multiplexed in order to deliver meaningful representations of the captured scene, in the form of a plurality of view. As a result, because the rows of each given view of the scene are built from pixels belonging to non-consecutive rows of the sensor pixel array, undesirable rolling shutter effects are amplified. For example, as shown on FIG. 2, the first row of view V1 of the scene is built from pixels belonging to row R11 of the sensor pixel array, whereas the second row of view V2 is built from pixels belonging to row R21 of the sensor pixel array. Time that elapses between the reading-out of these two rows of pixels R11 and R21 is longer than if they had been consecutive rows of the sensor pixel array. This explains why the undesirable rolling shutter effects are amplified in views generated from de-multiplexed plenoptic data.

It would hence be desirable to provide a technique for processing data acquired by a sensor pixel array that would be more adapted to plenoptic camera.

### 3. SUMMARY

According to an aspect of the present disclosure, a method for processing data acquired by a sensor pixel array of a plenoptic camera is provided. The sensor pixel array comprises a plurality of rows and columns of pixels and the plenoptic camera comprises a micro-lens array delivering a set of micro-lens images on said sensor pixel array, each micro-lens image covering at least partially a predetermined number of rows and a predetermined number of columns of the sensor pixels array, at least one of said numbers being an integer greater or equal to two. The proposed method for processing data acquired by a sensor pixel array of a plenoptic camera comprises reading-out rows or columns of pixels according to a reading-out order, said reading-out order being defined as a function of said predetermined number of rows and/or predetermined number of columns and of a number of micro-lens images.

Hence, the present disclosure relies on a different approach for reading-out rows or columns of pixels of a sensor pixel array, to better adapt to the particular distribution of data acquired by a sensor pixel array of a plenoptic camera. In that way, it is possible to adapt the reading-out order so that plenoptic data acquired by a sensor pixel array may be processed more efficiently, and in particular in a way that allows reducing rolling shutter undesirable effects within the views of the captured scene that are generated based on these plenoptic data.

According to a first implementation of the disclosure, the set of micro-lens images comprises N rows of M micro-lens images, and the reading-out comprises at least one iteration of reading-out a subset of rows of pixels from said sensor pixel array, as a function of said reading-out order, said subset of rows of pixels comprising N rows of pixels, said N rows of pixels having a same position within each of said N rows of micro-lens images.

According to a second implementation of the disclosure, the set of micro-lens images comprises M columns of N micro-lens images, and the reading-out comprises at least one iteration of reading-out a subset of columns of pixels from said sensor pixel array, as a function of said reading-out order, said subset of columns of pixels comprising M columns of pixels, said M columns of pixels having a same position within each of said M columns of micro-lens images.

In these ways, the time required to read-out all the pixels that make up a view corresponding to a representation of the scene seen from a predefined viewing angle is reduced compared to traditional rolling shutter technique. As a result, unwelcomed rolling shutter side effects within each view are reduced, and the global quality of each obtained view is thus improved. Moreover, the views are obtained more quickly, with no increase of the read-out speed. The proposed technique thus allows high quality high frame rate light field acquisition.

According to an embodiment of the first implementation, the rows of pixels comprised in a subset of rows of pixels are read-out sensibly at a same time.

According to an embodiment of the second implementation, the columns of pixels comprised in a subset of columns of pixels are read-out sensibly at a same time.

In these ways, the pixels that make up a view corresponding to a representation of the scene seen from a predefined viewing angle are all sensibly read-out at a same time. As a result, there is no rolling shutter effect within a view corresponding to a representation of the scene seen from a predefined viewing angle. Such a method may be seen as a pseudo-global shutter technique: although views corresponding to different vertical angles (in case of rows reading-out) or horizontal angles (in case of columns reading-out) are read-out at different instant of time, a whole view is read-out at a same time, as if a global shutter was used to capture each view separately.

According to another embodiment of the first implementation, the rows of pixels comprised in a subset of rows of pixels are read-out one after the other.

According to another embodiment of the second implementation, the columns of pixels comprised in a subset of columns of pixels are read-out one after the other.

In these ways, the proposed technique is close to traditional rolling shutter technique, since the rows (or columns) of pixels of the photo-sensor are read-out one after the other in both techniques. Only the reading order is modified. As a result, changes that are required to adapt existing rolling shutter photo-sensor to this new technique are reduced.

According to an embodiment of the first implementation, the method for processing data acquired by a sensor pixel array of a plenoptic camera comprises, subsequently to reading-out rows of pixels, processing the motion of an object within a plurality of views of a scene, by:

determining a first position (x1, y1, z1) of said object within a first view associated with a first vertical viewing angle, the depth z1 being determined as a function of a horizontal disparity between said first view and another view associated with the same vertical viewing angle but with a different horizontal viewing angle;

determining a second position (x2, y2, z2) of said object within a second view associated with a second vertical viewing angle different from the first vertical viewing angle, the depth z2 being determined as a function of a horizontal disparity between said second view and another view associated with the same vertical viewing angle but with a different horizontal viewing angle;

estimating the motion of said object between said first view and said second view, as a function of said first position and said second position.

In that way, it is possible to estimate intra-frame motion field, by estimating 2D or 3D apparent motion of a moving object between views corresponding to different vertical viewing angles. This may further be used to perform spatial and/or temporal interpolation, to generate high frame rate light field videos for example.

According to an embodiment, estimating the motion of said object between said first view and said second view takes account:

of a difference between said first position (x1, y1, z1) and said second position (x2, y2, z2) of said object; and

of a difference between a reading time associated with said first position and a reading time associated with said second position.

According to another embodiment, said difference between a reading time associated with said first position and a reading time associated with said second position is based only on a vertical component of each of said first and second positions.

According to an embodiment of the second implementation, the method for processing data acquired by a sensor pixel array of a plenoptic camera comprises, subsequently to reading-out columns of pixels, processing the motion of an object within a plurality of views of a scene, by:

determining a first position (x1, y1, z1) of said object within a first view associated with a first horizontal viewing angle, the depth z1 being determined as a function of a vertical disparity between said first view and another view associated with the same horizontal viewing angle but with a different vertical viewing angle;

determining a second position (x2, y2, z2) of said object within a second view associated with a second horizontal viewing angle different from the first horizontal viewing angle, the depth z2 being determined as a function of a vertical disparity between said second view and another view associated with the same horizontal viewing angle but with a different vertical viewing angle;

estimating the motion of said object between said first view and said second view, as a function of said first position and said second position.

In that way, it is possible to estimate intra-frame motion field, by estimating 2D or 3D apparent motion of a moving object between views corresponding to different horizontal viewing angles. This may further be used to perform spatial and/or temporal interpolation, to generate high frame rate light field videos for example.

According to an embodiment, estimating the motion of said object between said first view and said second view takes account:

of a difference between said first position (x1, y1, z1) and said second position (x2, y2, z2) of said object; and

of a difference between a reading time associated with said first position and a reading time associated with said second position.

According to another embodiment, said difference between a reading time associated with said first position and a reading time associated with said second position is based only on a horizontal component of each of said first and second positions.

The present disclosure also concerns a device for processing data acquired by a sensor pixel array of a plenoptic camera. The sensor pixel array comprises a plurality of rows and columns of pixels and the plenoptic camera comprises a micro-lens array delivering a set of micro-lens images on said sensor pixel array, each micro-lens image covering at least partially a predetermined number of rows and a predetermined number of columns of said sensor pixels array, at least one of said numbers being an integer greater or equal to two. Such a device comprises a module for reading-out rows or columns of pixels according to a reading-out order, said reading-out order being defined as a function of said predetermined number of rows and/or predetermined number of columns and of a number of micro-lens images.

The present disclosure also concerns a computer program product downloadable from a communication network and/or recorded on a medium readable by a computer and/or executable by a processor, comprising program code instructions for implementing the method as described above.

The present disclosure also concerns a non-transitory computer-readable medium comprising a computer program product recorded thereon and capable of being run by a processor, including program code instructions for implementing the method as described above.

Such a computer program may be stored on a computer readable storage medium. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

It is to be understood that both the foregoing general description and the following detailed description are exemplary and explanatory and are not restrictive of the disclosure, as claimed.

It must also be understood that references in the specification to “one embodiment” or “an embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### 4. BRIEF DESCRIPTION OF THE DRAWINGS

Embodiments of the present disclosure can be better understood with reference to the following description and drawings, given by way of example and not limiting the scope of protection, and in which:

FIG. 1, already described, presents an example of structure of a conventional plenoptic imaging device;

FIG. 2, already introduced, illustrates how views representative of a same scene seen under different viewing angles are generated, from plenoptic data acquired by a sensor pixel array;

FIGS. 3a and 3b show rows reading-out time profile of prior art rolling shutter technique when applied on plenoptic data acquired by a sensor pixel array, respectively at the sensor pixel array level and at the view level;

FIGS. 4a and 4b show rows reading-out time profile of a modified rolling shutter technique when applied on plenoptic data acquired by a sensor pixel array, respectively at the sensor pixel array level and at the view level, according to an embodiment of the present disclosure;

FIGS. 5a and 5b show rows reading-out time profile of a pseudo-global shutter technique when applied on plenoptic data acquired by a sensor pixel array, respectively at the sensor pixel array level and at the view level, according to an embodiment of the present disclosure;

FIG. 6 is a flow chart for illustrating the general principle of the proposed technique for estimating motion of an object, according to an embodiment of the present disclosure;

FIG. 7 is a schematic block diagram illustrating an example of an apparatus for processing data acquired by a sensor pixel array of a plenoptic camera, according to an embodiment of the present disclosure.

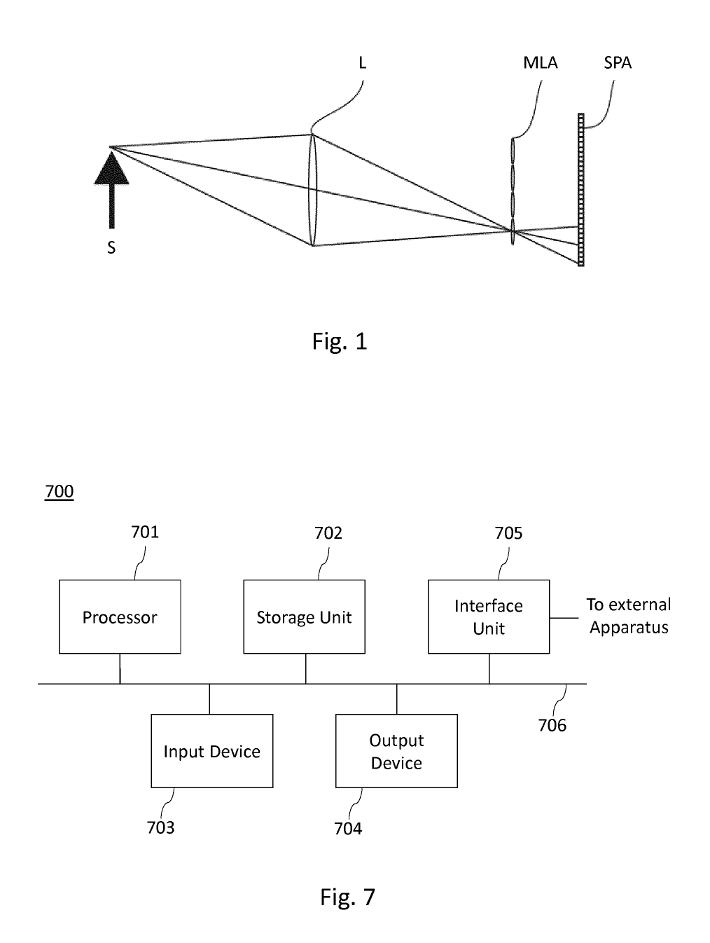

The components in the figures are not necessarily to scale, emphasis instead being placed upon illustrating the principles of the disclosure.

### 5. DETAILED DESCRIPTION

5.1 General Principle

The general principle of the present disclosure relies on a specific technique for processing data acquired by a sensor pixel array (SPA) of a plenoptic camera.

As it will be described more fully hereafter with reference to the accompanying figures, it is proposed in one aspect of the present disclosure to change the order according to which rows or columns of a sensor pixel array are read-out, to better adapt to light field content.

This disclosure may, however, be embodied in many alternate forms and should not be construed as limited to the embodiments set forth herein. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure as defined by the claims. Like numbers refer to like elements throughout the description of the figures.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

While not explicitly described, the present embodiments and variants may be employed in any combination or sub-combination.

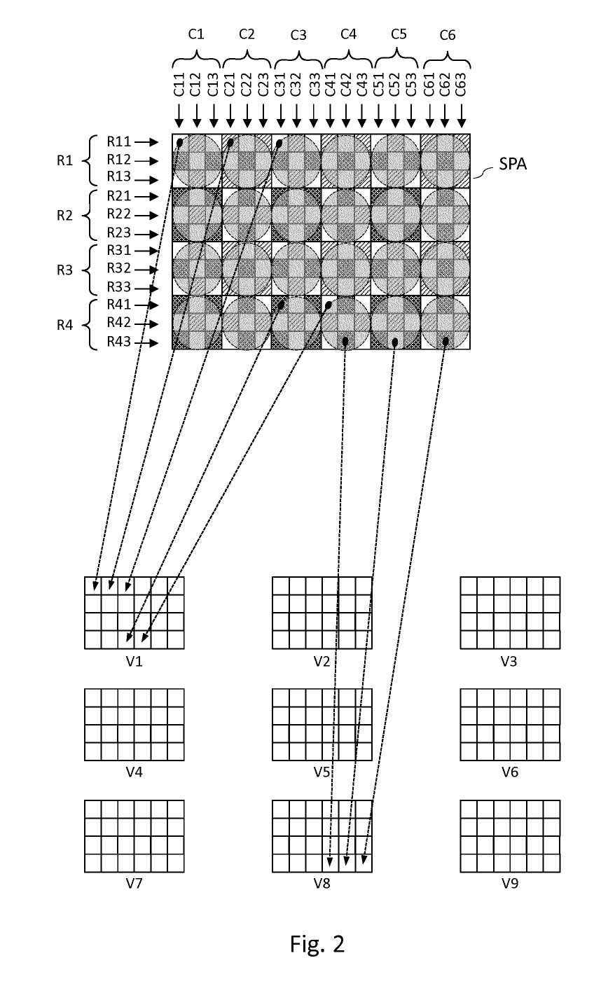

As already introduced above in relation with prior art, a plenoptic camera comprises a micro-lens array delivering a set of micro-lens images on a sensor pixel array. Each micro-lens image of said set of micro-lens images covers at least partially a predetermined number of rows and a predetermined number of columns of the sensor pixels array. Usually, all the micro-lens image of said set of micro-lens images are of same dimension, and each micro-lens image covers more than one row and/or column of pixels of the sensor pixel array. For example, in the example of FIG. 2, a set of twenty-four micro-lens images is delivered by the micro-lens array, each micro-lens image covering at least partially three rows and three columns of the sensor pixel array, thus allowing the generation of nine views (V1, V2, . . . , V9) of the scene seen under different viewing angles.

According to one aspect of the present disclosure, it is proposed a method for processing data acquired by a sensor pixel array, which comprises reading-out rows or columns of pixels according to a particular reading-out order. More precisely, this reading-out order is defined as a function of the predetermined number of rows and/or predetermined number of columns covered by each micro-lens image, and of a number of micro-lens images delivered by the micro-lens array on the sensor pixel array. In that way, it is possible to adapt the reading-out order so that plenoptic data acquired by a sensor pixel array may be processed more efficiently, and in particular in a way that allows reducing rolling shutter undesirable effects within the views of the captured scene that are generated based on these plenoptic data.

Different embodiments of a reading-out order according to the proposed technique are now detailed, and their advantages compared to the reading order of traditional rolling shutter technique are presented.

Throughout the rest of the document it is assumed that, for purposes of simplification, the reading-out order is a row reading-out order. However, it is to be understood that the disclosure can be embodied in various forms, and is not to be limited to the reading-out of rows of pixels. In particular, the proposed technique may rely on a column reading-out order without departing from the scope of the disclosure.

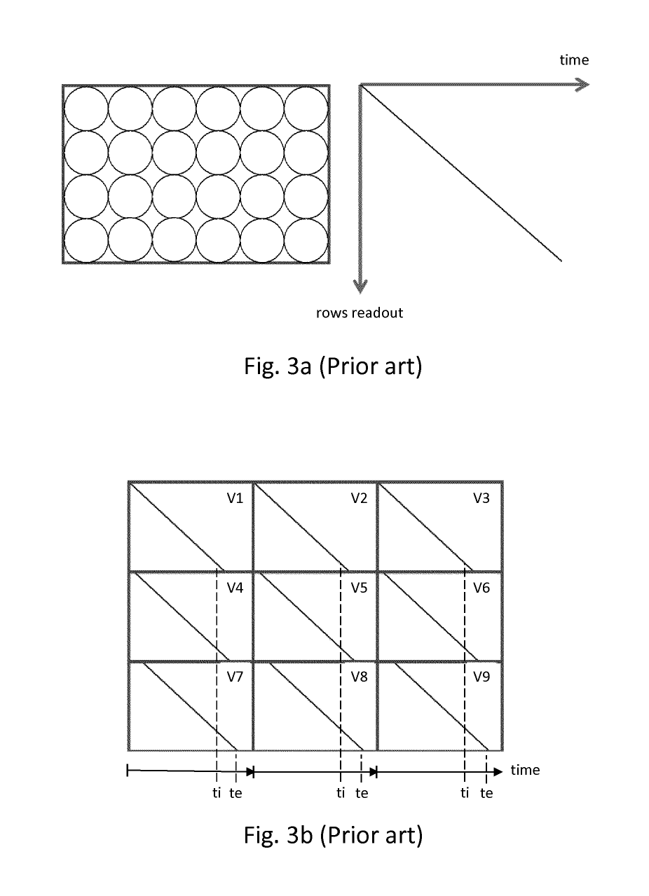

As already described in prior art, with traditional rolling shutter technique, the rows of the sensor pixel array are read-out sequentially, one after another, usually from top to bottom. Referring back to the example of FIG. 2, applying a traditional rolling shutter technique for reading-out rows of pixels of the sensor pixel array thus leads to the following reading-out order (from first row to be read-out to last row to be read-out): R11, R12, R13, R21, R22, R23, R31, R32, R33, R41, R42, R43. FIGS. 3a and 3b illustrate schematically time profiles associated with such prior art reading-out order. FIG. 3a shows the rows reading-out time profile according to a traditional rolling shutter technique, at the whole sensor pixel array level. FIG. 3b depicts the effect of such a traditional rolling shutter technique at each view (V1, V2, . . . , V9) level. Within each view V1 to V9 of FIG. 3b, the temporal progression of the reading-out of rows of the corresponding view is schematically indicated.

It should first be noted that views corresponding to a same vertical viewing angle (for example views V1, V2 and V3) follow the same temporal progression. This is inherent to a row reading-out order when applied to the particular distribution of light field data acquired by a sensor pixel array (this is thus not specific to prior art rolling shutter technique). Indeed, referring back to FIG. 2, one can easily noticed that pixels that are used to build views V1, V2 and V3 come from the same rows of pixels of the sensor pixel array. For example, the first row of view V1, the first row of view V2 and the first row of view V3 are all built from pixels belonging to row R11 of the sensor pixel array.

According to the presented prior art technique, wherein rows of the sensor pixel array are read-out from top to bottom, row R12 is read-out right after R11. As it can be noticed on FIG. 2, pixels belonging to this row R12 are used to build the first row of view V4, the first row of view V5 and the first row of view V6.

It therefore appears that a row reading-out order from top to bottom at the sensor pixel array level results in an interlaced reading-out order at the view level:

pixels of the first row of V1, V2 and V3 are first read-out (R11 read-out);

then pixels of the first row of V4, V5 and V6 are read-out (R12 read-out);

then pixels of the first row of V7, V8 and V9 are read-out (R13 read-out);

then pixels of the second row of V1, V2 and V3 are read-out (R21 read-out);

then pixels of the second row of V4, V5 and V6 are read-out (R22 read-out);

and so on.

As a result, the time needed to read-out all the rows of the sensor pixel array is sensibly the time needed to read-out all the pixels used to build any of view V1 to V9 during the de-multiplexing stage. In other words, none of view V1 to V9 may be fully generated until the reading-out time of the last rows of the sensor pixel array has been reached. This can be observed in FIG. 3b, which shows that at a short time ti before time to at which all the rows of the sensor pixel array have been read-out, none of views V1 to V9 may be fully generated.

It is proposed in one embodiment of the present disclosure, to modify the reading-out order to better adapt to the particular distribution of data acquired by a sensor pixel array (SPA) of a plenoptic camera. More precisely, if the set of micro-lens images delivered by the micro-lens array on the sensor pixel array comprises N rows (R1, R2, . . . , RN) of M micro-lens images it is proposed a reading-out method that comprises at least one iteration of reading-out a subset of rows of pixels from the sensor pixel array, wherein said subset of rows of pixels comprises N rows of pixels having a same position within each of said N rows of micro-lens images.

In other words, if applied to the example described in FIG. 2, it is proposed to read-out, at first, a first subset of rows of pixels comprising the rows R11, R21, R31, R41; then a second subset of rows of pixels comprising the rows R12, R22, R32, R42; and finally a third set of pixels comprising the rows R13, R23, R33, R43.

As it can be noticed:

the first subset of rows of pixels comprises four rows of pixels, corresponding to the rows of pixels having the first position within the rows of micro-lens images R1, R2, R3 and R4;

the second subset of rows of pixels comprises four rows of pixels, corresponding to the rows of pixels having the second position within the rows of micro-lens images R1, R2, R3 and R4;

the third subset of rows of pixels comprises four rows of pixels, corresponding to the rows of pixels having the third position within the rows of micro-lens images R1, R2, R3 and R4.

Such a reading-out order that takes account of the position of each row of pixels within the rows of micro-lens images delivered on the sensor pixel array is interesting, since each subset of rows thus created comprise all the pixels that are used to build a specific view during the de-multiplexing stage. In that way, by processing one after the other the obtained subsets of rows of pixels, the time required to read-out all the pixels used to build a view corresponding to a representation of the scene seen from a predefined viewing angle is reduced compared to traditional rolling shutter technique. As a result, undesirable rolling shutter effects are reduced within each view, and the global quality of each obtained view is thus improved. Moreover, because the views are obtained more quickly, with no increase of the read-out speed, the proposed technique allows high quality and high frame rate light field acquisition.

As it will be presented below, in relation with several other embodiments of the present disclosure, rows of pixels within a same subset of rows of pixels may be read-out in different ways (it is assumed throughout the rest of the document that a “subset of rows of pixels” referred to as a subset of rows of pixels created accordingly to the proposed technique previously described).

5.2 Modified Rolling Shutter Technique

According to one embodiment of the present disclosure, the rows of pixels comprised in a subset of rows of pixels are read-out sequentially, one after the other. Thus, according to this embodiment, the general principle of a rolling shutter remains unchanged: rows of pixels of the sensor pixel array are still read-out sequentially, one after another. However, instead of reading-out from top to bottom, a new reading order is proposed. This new rolling shutter technique is referred to as “modified rolling shutter technique” throughout the rest of this document (by contrast with the “traditional rolling shutter technique” of prior art).

Referring back to the example of FIG. 2, applying such a modified rolling shutter technique for reading-out rows of pixels of the sensor pixel array leads to the following reading-out order (from first row to be read-out to last row to be read-out): R11, R21, R31, R41, R12, R22, R32, R42, R13, R23, R33, R43.

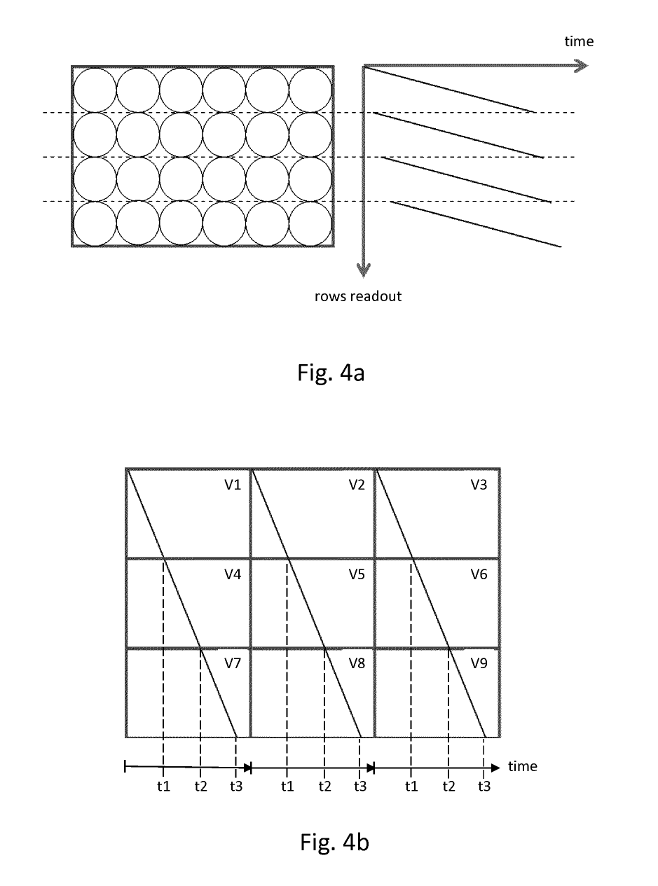

FIGS. 4a and 4b, built on the same model as FIGS. 3a and 3b, illustrate schematically time profiles associated with such a modified rolling shutter technique. FIG. 4a shows the rows reading-out time profile according to this new rolling shutter technique, at the whole sensor pixel array level. FIG. 4b depicts the effect of such a new rolling shutter technique at each view (V1, V2, . . . , V9) level. Within each view V1 to V9 of FIG. 4b, the temporal progression of the reading-out of rows of the corresponding view is schematically indicated.

When compared to FIG. 3b, FIG. 4b clearly shows that, assuming that the reading-out speed is the same in both situation, the time after which a view (V1, . . . , V9) is obtained is reduced:

rows comprising pixels necessary to build views V1, V2 and V3 have all been read-out at time t1;

rows comprising pixels necessary to build views V4, V5 and V6 have all been read-out between time t1 and t2; and

rows comprising pixels necessary to build views V7, V8 and V9 have all been read-out between time t2 and t3.

Considering the example depicted in FIGS. 2, 3 and 4, the time needed to read-out all the pixels composing a view is divided by 3 with the proposed modified rolling shutter technique, compared to traditional rolling shutter technique (time t3 of FIG. 4b corresponds to time to of FIG. 3b, if reading-out speed is the same in both situation).

Thus, with the proposed modified rolling shutter technique, the rolling shutter effect within each view is reduced compared to traditional rolling shutter technique. As a result, delivered views are of better quality with the proposed rolling shutter technique. Moreover, there is no need anymore to wait until almost all the rows of the sensor pixel array have been read-out to obtain some fully generated views. For example, as soon as time t1 has been reached (i.e. well before t3), it is possible to build views V1, V2 and V3. And as soon as time t2 has been reached (i.e. well before t2), it is possible to build views V4, V5 and V6. Any processing based on the generated views may thus begin earlier if the proposed modified rolling shutter technique is used, compared to traditional rolling shutter technique. Finally, because the proposed modified rolling shutter technique stays close to the traditional rolling shutter technique (rows of pixels of the sensor pixel array are read-out one after the other in both techniques, only the reading order is modified), changes that are required to adapt existing rolling shutter based sensor pixel array are minimized.

5.3 Pseudo-Global Shutter Technique

According to another embodiment of the present disclosure, the rows of pixels comprised in a subset of rows of pixels are read-out sensibly at a same time. Such a shutter technique if referred to as a “pseudo-global shutter” technique throughout the rest of this document, for reasons that will be given hereafter.

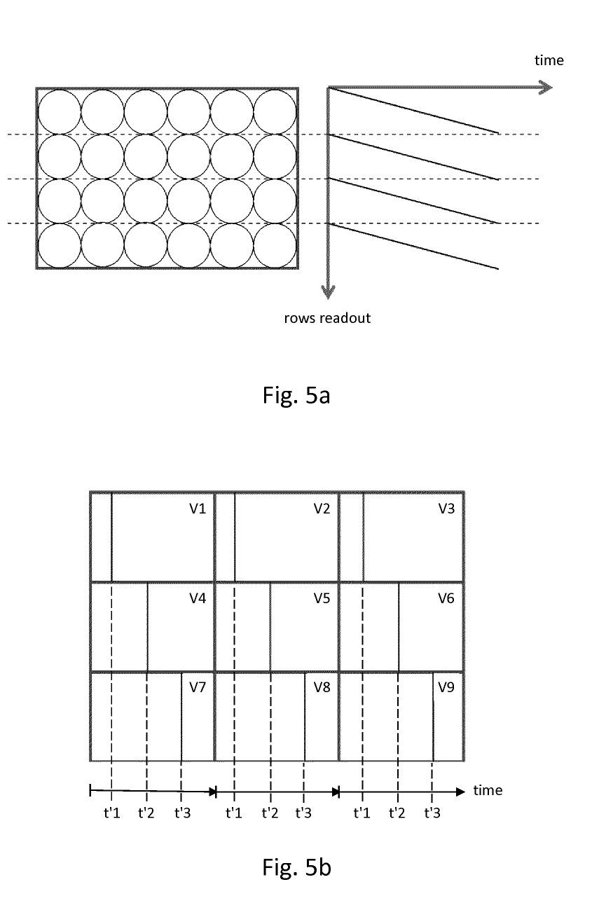

FIGS. 5a and 5b, built on the same model as FIGS. 3a and 3b, illustrate schematically time profiles associated with such a pseudo-global shutter technique. FIG. 5a shows the rows reading-out time profile according to this pseudo-global shutter technique, at the whole sensor pixel array level. FIG. 5b depicts the effect of such a pseudo-global technique at each view (V1, V2, . . . , V9) level. Within each view V1 to V9 of FIG. 5b, the temporal progression of the reading-out of rows of the corresponding view is schematically indicated.

As described in FIG. 5b, according to the proposed technique:

rows comprising pixels necessary to build views V1, V2 and V3 are all sensibly read-out at the same time t′1;

rows comprising pixels necessary to build views V4, V5 and V6 are all sensibly read-out at the same time t′2;

rows comprising pixels necessary to build views V7, V8 and V9 are all sensibly read-out at the same time t′3.

Applied to the example of FIG. 2, such a pseudo-global shutter technique results in reading-out subsets of rows sequentially, in the following order (from first subset of rows to be read-out to last subset of rows to be read-out): (R11, R21, R31, R41), (R12, R22, R32, R42), (R13, R23, R33, R43). All the rows in a same subset of rows are read-out sensibly at the same time. For example, rows R11, R21, R31 and R41 of the first subset of rows are sensibly read-out at the same time.

Considering each view separately, because a subset of rows according to the present disclosure comprises all the pixels that are used to build a specific view, everything happens as if a global shutter had been employed (at a given view level). In other words, although pixels comprised in views corresponding to different vertical angles are read-out at different time, all the pixels comprised in a given view are read-out at a same time, as if a global shutter was used to capture each view separately. This is why this technique is referred to as pseudo-global shutter in the present disclosure. Thus, compared to the modified rolling shutter technique proposed in relation with FIG. 4b, the pseudo-global shutter of FIG. 5b is even more efficient, since there are now no undesirable rolling shutter effects within views V1 to V9. As for the modified rolling shutter technique, there is no need to wait until almost all the rows of the sensor pixel array have been read-out to obtain some fully generated views, and any processing based on the generated views may thus begin earlier if the proposed pseudo-global shutter technique is used, compared to traditional rolling shutter technique.

5.4 Motion Field Estimation

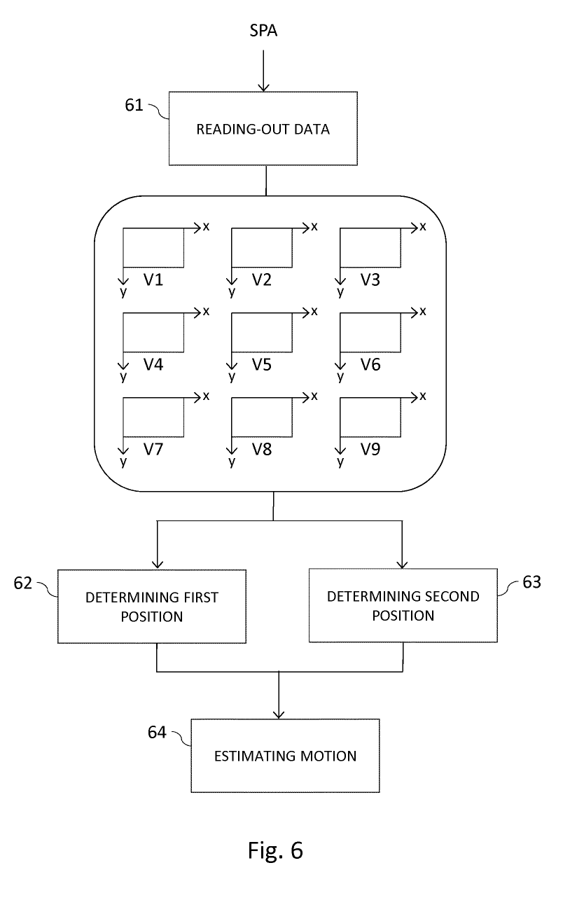

FIG. 6 is a flow chart for explaining a method for processing data acquired by a sensor pixel array of a plenoptic camera according to an embodiment of the present disclosure. More particularly, the benefits of using a shutter technique relying on a reading-out order according to the proposed technique (either a modified rolling shutter technique or a pseudo-global shutter technique) is now explained, in relation with a common process which comprises estimating the motion of an object between views obtained at de-multiplexing stage.

Such a process may for example be used to perform high frame rate 3D motion estimation. It may also be used to estimate high frame rate light field videos, by using spatial and temporal interpolation.

At step 61, data acquired by a sensor pixel array of a plenoptic camera are read-out, according to a reading-out order as already described above (modified rolling shutter technique or pseudo-global shutter technique). By de-multiplexing the data read-out, a plurality of views (V1, V2, . . . , VP) of the scene captured by the plenoptic camera are delivered, each view corresponding to a representation of the scene seen under a specific viewing angle. A viewing angle associated with a given view can be defined as the composition of two components: a vertical viewing angle and a horizontal viewing angle.

For example, referring back to the configuration of FIG. 2, nine views (V1, V2, . . . , V9) are delivered, corresponding to nine different viewing angles of a same scene. Views V1 to V9 can be categorized in groups of views associated with a same vertical viewing angle or a same horizontal viewing angle. Thus, considering the micro-lens array arrangement that delivers the set of micro-lens images of FIG. 2:

views V1, V2, V3 are associated with a same vertical viewing angle vVA1;

views V4, V5, V6 are associated with a same vertical viewing angle vVA2;

views V7, V8, V9 are associated with a same vertical viewing angle vVA3;

views V1, V4, V7 are associated with a same horizontal viewing angle hVA1;

views V2, V5, V8 are associated with a same horizontal viewing angle hVA2;

views V3, V6, V9 are associated with a same horizontal viewing angle hVA3;

with vVA1, vVA2 and vVA2 being different; and hVA1, hVA2 and hVA3 being different.

Still assuming that the reading-out relies on the reading-out of rows of pixels, and because of the specific reading-out order of the proposed technique, pixels used to build views V1, V2, V3 are read-out before pixels used to build V4, V5, V6; which are themselves read out before pixels used to build views V7, V8, V9. As a result, a moving object in the captured scene may have different positions, when comparing views corresponding to different vertical viewing angle.

It should also be noticed that:

pixels used to build respective rows of views V1, V2 and V3 are read-out at a same time;

pixels used to build respective rows of views V4, V5 and V6 are read-out at a same time;

pixels used to build respective rows of views V7, V8 and V9 are read-out at a same time.

As a result, a moving object has the same position, when comparing views corresponding to a same vertical viewing angle but to different horizontal angles (the position remains the same, but the objet is seen under different horizontal viewing angles).

These characteristics linked to the proposed reading-out technique (either the modified rolling shutter technique or the pseudo-global shutter technique of the present disclosure) are used to estimate the 3D motion of such a moving object between views corresponding to different vertical viewing angles.

At step 62, a first position of the object within a first view associated with a first vertical viewing angle, for example V1, is determined. This position may be expressed by some coordinates (x1; y1; z1), where (x1; y1) are the coordinates of the object within the view V1, and z1 represents a depth of the object within the scene as represented in V1. The depth z1 is determined as a function of a horizontal disparity between said view V1 and another view associated with the same vertical viewing angle VA1 but with a different horizontal viewing angle, for example view V3.

A process fairly similar to the one that has just been described is performed at step 63, where a second position of the object within a second view associated with a second vertical viewing angle different from the first vertical viewing angle, for example V4, is determined. Again, this position may be expressed by some coordinates (x2; y2; z2), where (x2; y2) are the coordinates of the object within the view V4, and z2 represents a depth of the object within the scene as represented in V4. The depth z2 is determined as a function of a horizontal disparity between said view V4 and another view associated with the same vertical viewing angle VA2 but with a different horizontal viewing angle, for example view V6.

At step 64, the motion of the object between said first view (V1 in the given example) and said second view (V4 in the given example), is estimated, as a function of said first position and said second position.

In an embodiment of the present disclosure, estimation of the motion of the object takes account of both a difference between the first position (x1, y1, z1) and the second position (x2, y2, z2) of said object and of a difference between a reading time associated with said first position and a reading time associated with said second position on the other hand. In that way, it is possible to estimate the motion speed of the object between the first and second position.

In an embodiment of the present disclosure, the difference between the reading time associated with the first position and the reading time associated with the second position is based only on a vertical component of each of said first and second positions. This is for example the case when a modified rolling shutter technique according to the present disclosure is used to read-out rows of pixels of the sensor pixel array.

In another embodiment of the present disclosure, the difference between the reading time associated with the first position and the reading time associated with the second position is based only on the first and second views on which the motion estimation is based. This is for example the case when a pseudo-global shutter technique according to the present disclosure is used to read-out rows of pixels of the sensor pixel array.

While the present disclosure has been described with reference to exemplary embodiments relying on reading-out rows of the sensor pixel array, it will be understood by those of ordinary skill in the pertinent art that various changes may be made and equivalents may be substituted for the elements thereof without departing from the scope of the disclosure. More particularly, all the embodiments described may be adapted so that they rely on reading-out columns of the sensor pixel array instead of rows. It should also be noted that, for reasons of simplification, the present disclosure has been described with reference to one or more examples where micro-lenses of the micro-lens array are distributed according to an orthogonal arrangement. However, people skilled in the art will recognize that the proposed technique is not to be limited to micro-lenses orthogonal arrangement. For example, according to another embodiment of the present disclosure, the proposed technique for processing data acquired by a sensor pixel array of a plenoptic camera may also be implemented when micro-lenses of the micro-lens array are distributed according to a quincunx arrangement.

5.5 Device

FIG. 7 is a schematic block diagram illustrating an example of a device for processing data acquired by a sensor pixel array (SPA) of a plenoptic camera according to an embodiment of the present disclosure. In an embodiment, such a device may be embedded in an image sensor. In another embodiment, it may be an external device connected to an image sensor.

An apparatus 700 illustrated in FIG. 7 includes a processor 701, a storage unit 702, an input device 703, an output device 704, and an interface unit 705 which are connected by a bus 706. Of course, constituent elements of the computer apparatus 700 may be connected by a connection other than a bus connection using the bus 706.

The processor 701 controls operations of the apparatus 700. The storage unit 702 stores at least one program to be executed by the processor 701, and various data, including for example parameters used by computations performed by the processor 701, intermediate data of computations performed by the processor 701, and so on. The processor 701 is formed by any known and suitable hardware, or software, or a combination of hardware and software. For example, the processor 701 is formed by dedicated hardware such as a processing circuit, or by a programmable processing unit such as a CPU (Central Processing Unit) that executes a program stored in a memory thereof.

The storage unit 702 is formed by any suitable storage or means capable of storing the program, data, or the like in a computer-readable manner. Examples of the storage unit 702 include non-transitory computer-readable storage media such as semiconductor memory devices, and magnetic, optical, or magneto-optical recording media loaded into a read and write unit. The program causes the processor 701 to perform a process for processing data acquired by a sensor pixel array according to an embodiment of the present disclosure as described previously. More particularly, the program causes the processor 701 to read-out rows or column of pixels of the sensor pixel array according to a specific reading-out order. Such a reading-out order may be stored into storage unit 702.

The input device 703 is formed for example by a sensor pixel array.

The output device 704 is formed for example by any image processing device, for example for de-multiplexing plenoptic data read-out from the sensor pixel array, or for estimating motion of an object of the scene.

The interface unit 705 provides an interface between the apparatus 700 and an external apparatus. The interface unit 705 may be communicable with the external apparatus via cable or wireless communication. In some embodiments, the external apparatus may be a display device for example.

Although only one processor 701 is shown on FIG. 7, it must be understood that such a processor may comprise different modules and units embodying the functions carried out by apparatus 700 according to embodiments of the present disclosure, among which a module for reading-out rows or columns of pixels according to a reading-out order.

These modules and units may also be embodied in several processors 701 communicating and co-operating with each other.

1. A method for processing data acquired by a sensor pixel array (SPA) of a plenoptic camera, said sensor pixel array (SPA) comprising a plurality of rows and columns of pixels and said plenoptic camera comprising a micro-lens array (MLA) delivering a set of micro-lens images on said sensor pixel array (SPA), each micro-lens image covering at least partially a number of rows and a number of columns of said sensor pixels array, at least one of said numbers being an integer greater or equal to two, wherein said method comprises reading-out rows or columns of pixels according to a reading-out order which is defined as a function of said number of rows and/or number of columns and of a number of micro-lens images.

2. The method of claim 1, wherein said set of micro-lens images comprises N rows (R1, R2, . . . , RN) of M micro-lens images, and wherein said reading-out comprises at least one iteration of reading-out a subset of rows of pixels from said sensor pixel array, as a function of said reading-out order, said subset of rows of pixels comprising N rows of pixels, said N rows of pixels having a same position within each of said N rows of micro-lens images.

3. The method of claim 1, wherein said set of micro-lens images comprises M columns (C1, C2, . . . , CM) of N micro-lens images, and wherein said reading-out comprises at least one iteration of reading-out a subset of columns of pixels from said sensor pixel array, as a function of said reading-out order, said subset of columns of pixels comprising M columns of pixels, said M columns of pixels having a same position within each of said M columns of micro-lens images.

4. The method of claim 2, wherein the rows of pixels comprised in a subset of rows of pixels are read-out sensibly at a same time.

5. The method of claim 3, wherein the columns of pixels comprised in a subset of columns of pixels are read-out sensibly at a same time.

6. The method of claim 2, wherein the rows of pixels comprised in a subset of rows of pixels are read-out one after the other.

7. The method of claim 3, wherein the columns of pixels comprised in a subset of columns of pixels are read-out one after the other.

8. The method of claim 2, wherein it comprises, subsequently to reading-out rows of pixels, processing the motion of an object within a plurality of views (V1, V2, . . . , VP) of a scene, by:
determining a first position (x1, y1, z1) of said object within a first view Vi1 associated with a first vertical viewing angle VA1, the depth z1 being determined as a function of a horizontal disparity between said first view Vi1 and another view ViX associated with the same vertical viewing angle VA1 but with a different horizontal viewing angle;
determining a second position (x2, y2, z2) of said object within a second view Vi2 associated with a second vertical viewing angle VA2 different from the first vertical viewing angle VA1, the depth z2 being determined as a function of a horizontal disparity between said second view Vi2 and another view ViY associated with the same vertical viewing angle VA2 but with a different horizontal viewing angle;
estimating the motion of said object between said first view Vi1 and said second view Vi2, as a function of said first position and said second position.

9. The method of claim 8, wherein estimating the motion of said object between said first view Vi1 and said second view Vi2 takes account:
of a difference between said first position (x1, y1, z1) and said second position (x2, y2, z2) of said object; and
of a difference between a reading time associated with said first position and a reading time associated with said second position.

10. The method of claim 9, wherein said difference between a reading time associated with said first position and a reading time associated with said second position is based only on a vertical component of each of said first and second positions.

11. The method of claim 3, wherein it comprises, subsequently to reading-out columns of pixels, processing the motion of an object within a plurality of views (V1, V2, . . . , VP) of a scene, by:
determining a first position (x1, y1, z1) of said object within a first view Vi1 associated with a first horizontal viewing angle VA1, the depth z1 being determined as a function of a vertical disparity between said first view Vi1 and another view ViX associated with the same horizontal viewing angle VA1 but with a different vertical viewing angle;
determining a second position (x2, y2, z2) of said object within a second view Vi2 associated with a second horizontal viewing angle VA2 different from the first horizontal viewing angle VA1, the depth z2 being determined as a function of a vertical disparity between said second view Vi2 and another view ViY associated with the same horizontal viewing angle VA2 but with a different vertical viewing angle;
estimating the motion of said object between said first view Vi1 and said second view Vi2, as a function of said first position and said second position.

12. The method of claim 11, wherein estimating the motion of said object between said first view Vi1 and said second view Vi2 takes account:
of a difference between said first position (x1, y1, z1) and said second position (x2, y2, z2) of said object; and
of a difference between a reading time associated with said first position and a reading time associated with said second position.

13. The method of claim 12, wherein said difference between a reading time associated with said first position and a reading time associated with said second position is based only on a horizontal component of each of said first and second positions.

14. A device for processing data acquired by a sensor pixel array (SPA) of a plenoptic camera, said sensor pixel array (SPA) comprising a plurality of rows and columns of pixels and said plenoptic camera comprising a micro-lens array (MLA) delivering a set of micro-lens images on said sensor pixel array (SPA), each micro-lens image covering at least partially a number of rows and a number of columns of said sensor pixels array, at least one of said numbers being an integer greater or equal to two, wherein said device comprises a module for reading-out rows or columns of pixels according to a reading-out order, said reading-out order being defined as a function of said number of rows and/or number of columns and of a number of micro-lens images.

15. A computer program product downloadable from a communication network and/or recorded on a medium readable by a computer and/or executable by a processor, comprising program code instructions for implementing a method according to claim 1.

16. A non-transitory computer-readable medium comprising a computer program product recorded thereon and capable of being run by a processor, including program code instructions for implementing a method according to claim 1.
